(19) United States
(12) Patent Application Publication
(10) Pub. No.: US 2023/0194271 A1
(43) Pub. Date: Jun. 22, 2023

(54) Systems and Methods for Preparing an Electric Vehicle for Travel

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/970,101

(22) Filed: Oct. 20, 2022

Related U.S. Application Data
(60) Provisional application No. 63/273,439, filed on Oct. 29, 2021.

(51) Int. Cl. G01C 21/34; G01C 21/36; B60L 53/62

(52) U.S. Cl. CPC G01C 21/343; G01C 21/3697; B60L 53/62; G01C 21/3679

(57) ABSTRACT

A user may specify via a user device an origin, a destination, a date of arrival and a time of arrival at a destination. A server may determine a route from the origin to the destination, the amount of time for travel from the origin to the destination and time for departure. The server may also determine whether the battery should be charged prior to departure and if it does, the server may control the charging process. Time for departure and charging may be reported to the user. Message may be sent to ask the user to connect the electric vehicle to the charger.

### BACKGROUND

Embodiments of the present invention relate an electric vehicle and a server or an application on a user device (e.g., smart phone, tablet, handheld) that can prepare electric vehicle for travel.

User devices such as smartphones, tablets, portable computers may be used by the user to maintain their calendar in information regarding contacts. A user may indicate in their calendar application the date and time of an anticipated trip using an electric vehicle. It would be desirable if the user device or a server could cooperate could use the data from the user's device, and/or other sources, to prepare the electric vehicle for the trip.

### SUMMARY

In an example embodiment, the calendar application and/or the contact application on a user device cooperates with another application, that runs on the user device, and/or a server to prepare an electric vehicle for a trip. The user, via the data from the calendar data, the contact data or directly to the user device and/or server indicates the date, desired time of arrival and a destination of a planned trip. The user device and/or the server uses the information to determine, among other things, a route, charging stations along the route, a schedule for the trip, and a departure time. The user device and/or the server reports the departure time to the user. The departure time may be reported via the calendar application on the user device.

The user device and/or the server may also determine the amount of charge the battery of the electric vehicle will need to store to be able to drive at least the first leg of the route or possibly even the entire trip to the destination. The user device and/or the server may determine (e.g., calculate) the amount of time it will take to transfer the amount of charge needed (e.g., charge the battery) to drive at least the first leg of the route. Having calculated the departure time and the amount of time it will take to charge the battery, the user device and/or the server reports to the user a time to start charging the vehicle. The message informs the user that the electric vehicle needs to be attached (e.g., connected to) to the charger at or before the time to start charging (e.g., transferring energy). For example, if the departure time is calculated to be 7 AM and the amount of time needed to charge the battery for at least the first leg is two hours, then the time to start charging is determined and reported as 5 AM.

If the battery needs to be charged, the user device and/or the server may determine if the charger is connected to the electric vehicle. If the charger is connected to the electric vehicle, user device and/or server instructs the charger to deliver energy to the battery. Energy delivery continues until the present amount of charge on the battery is greater than the amount of charge needed for at least the first leg.

A third person, such as a supervisor or a dispatcher, may provide tasks for the user to perform during the trip. The user device and/or the server may adjust the route information, including the departure time, the start of charging time, and/or the amount of energy for the first leg to enable the user to perform the assigned tasks. The user device and/or the server may also provide a task checklist to the user.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of an example embodiment of a trip preparation system.

FIG. 2 the diagram of trip data.

FIG. 3 is a diagram of roads and cities between an origin and a destination.

FIG. 4 is a diagram of an example embodiment of a charger.

FIG. 5 is a timing diagram of the trip, calculated times and amounts of time.

FIGS. 6 and 7 are a flow diagrams of a method for preparing the electric vehicle for the trip.

### DETAILED DESCRIPTION

### Overview

In an example embodiment, a system for preparing the electric vehicle 110 for a trip includes server 140, user device 130, network 120 and charger 112. The server 140 may have access to data from various databases 150-162. The user device may run applications such as calendar application 132, contact application 134 and todo application 136, each of which may provide data for preparing the electric vehicle 110 for the trip.

If the user of an electric vehicle uses a user device (e.g., tablet, smartphone, portable computer) to keep track of calendar events (e.g., trips, appointments), the user device and/or a server may prepare the electric vehicle for the calendar event and to remind the user when the electric vehicle must be charged to travel for the event. The user device and/or the server may also plan the travel such as route, schedule, locations of charging stations, locations for stops all consistent with the user's desired arrival time at the calendar event.

In an example embodiment, the server 140 receives calendar data from the user device 130. The server 140 may also receive contact data and todo data. The server 140 analyzes the calendar data to identify calendar events, in this example a trip, scheduled by the user. The server 140 may use the data from the user device 130, in addition to data from databases 150-162 if needed, to determine the origin, destination and the desired arrival time of the trip. If there is not sufficient information for the server 140 to determine the origin, destination or the desired arrival time, the server 140 may request such information from the user.

The server 140 plans the trip using the information from the user, the user data (e.g., 132-136) and/or database data (e.g., 150-162). For example, the server 140 may plan a route. The route may include several legs (e.g., 512-516). The trip may include several stops (e.g., 512-516). The stopped may be needed to recharge the battery 114 or for the user to perform a task (e.g., drop-off, pickup). The server 140 may estimate energy consumption by the electric vehicle 110 to determine the distances that may be traveled before recharging the battery 114 is needed. The server 140 may also determine the amount of energy that must be transferred to (e.g., charge) the battery 114, so the electric vehicle 110 can drive to the next leg of the trip. The server 140 may also estimate the amount of time it will take at each location to recharge the battery or to perform the task. The server 140 may use such information to determine how long it will take to travel from the origin to the destination, which is the duration of the trip (e.g., amount of time for travel 520).

The server 140 may also create a schedule (e.g., timeline) for the trip. The schedule may be reported to the user. The schedule may be reported to the user device 130 and incorporated into the calendar data for display to the user. The server 140 may determine a time to start transferring energy to the battery (e.g., charging) so the electric vehicle 110 can travel at least the first leg of the trip. The server 140 may also send reminders to the user regarding the trip and anything the user should do to prepare for the trip. The server 140 may also provide a list of tasks to be performed by the driver while in route.

The server 140 may control the charger 112 to start charging the battery 114 prior to the trip. The server 140 may start charging the battery consistent with the previously determined schedule. The server 140 may also reserve time at a charging station to charge the battery prior to the trip. Server 140 may inform the user of the reservation.

The Server vs. The User Device

The user device 130 may perform some or all of the functions of the server 140. In an example embodiment, the user device 130 performs all of the functions of the server 140 discussed herein and the server 140 is omitted. In another example embodiment, the user device 130 performs some of the functions of the server 140 and the server performs the remainder of the functions. In another example embodiment, the user device 130 and the server 140 cooperate to perform the functions discussed herein. Below, the server 140 is described as performing the operations of the system for preparing the electric vehicle 110 for a trip. The user device 130 may perform the same operations.

Although only the server 140 is shown as having access to the databases 150-162, the user device 130 may also have access to the databases 150-162 via the network 120. The user device 130 and/or the server 140 may communicate with the charger 112 and/or the electric vehicle 110. The user device 130 and/or the server 140 may control the operation of the charger 112. The user device 130 and/or the server 140 may control some operations of the electric vehicle 110, such as presenting information to the user.

The user device 130 may provide and present information to the user. The user device 130 may include a display for presenting information to user. The user device 130 may include an audible alarm to alert the user to a notice (e.g., reminder) that the user should read. The server 140 may also provide and present information to the user via user device 130. The user device 130 and/or the server 140 may present information to the user via the electric vehicle 110. The electric vehicle 110 may include a display that may present notices from the user device 130 and/or the server 142 the user. The electric vehicle 110 may further include a speaker for providing audible notices.

### The User Device

A person may use the user device 130 to maintain a calendar using the calendar application 132, contact information using the contact application 134 and a list of tasks using the todo application 136. A user may indicate a planned trip (e.g., appointment, event) on the calendar application 132. The user may specify a desire date and time of arrival at the destination. The user may further provide the destination and/or the origin. The calendar application may specify the time and date of an appointment with a particular person. The contact application 134 may provide the residence or business location of the user.

The user device 130 may send the calendar and contact data to the server 140 via the network 120. The server 140 may use the information from the user device 130 and the information to which it has access (e.g., databases 150-162) to determine a route and a departure time in order to arrive at the destination at the desired arrival time, to perform any assigned tasks along the way, and to stop to recharge the battery of the electric vehicle 110 as needed. The server 140 may provide the departure time (e.g., time for departure 222) to the user device 130. The user device 130 may store the departure time in the calendar application 132 and inform the user of the departure time.

The person may update or change the destination or desired arrival time of a planned trip via the user device 130 at any time. Responsive to a change of destination or desired arrival time, the server 140 may determine an updated the route and/or the time for departure 222. The server 140 may provide the updated time for departure 222 to the user device 130. The user device 130 may update the calendar application 132 and provide the updated time for departure 222 to the user.

Server and Data from Databases

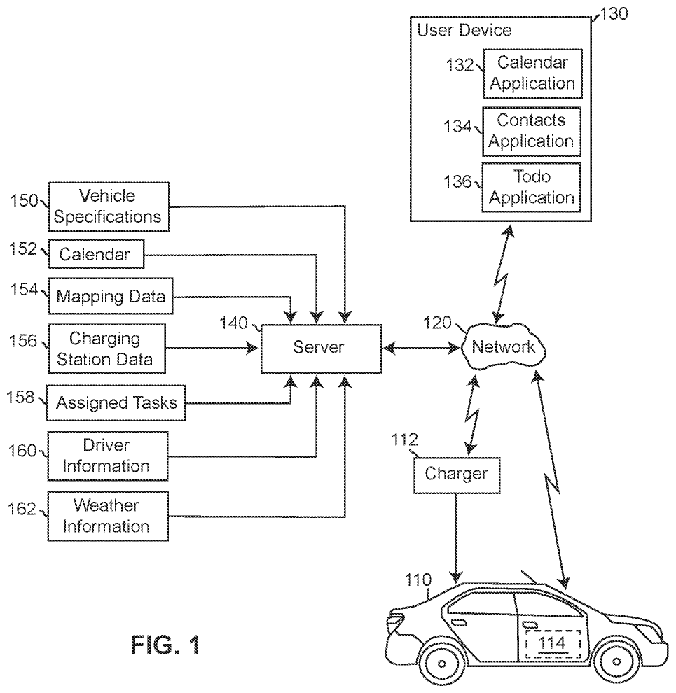

The server 140, as best shown in FIG. 1, has access to information in databases 150-162. The server 140 may access the data in the databases 150-162 in any manner. The server 140 may perform calculations on the data received from the databases 150-162. The server 140 may provide updated information to the databases 150-162.

In an example embodiment, the server 140 may have access to vehicle specifications 150, which provides data regarding the specifications of the electric vehicle 110. The specifications of the electric vehicle 110 includes data regarding the characteristics and operation of the electric vehicle 110. The server 140 may use information from the vehicle specifications 150 to determine a relationship between an amount of charge on the battery of the electric vehicle 110 and the distance (e.g., range) the electric vehicle 110 may travel. The server 140 may further determine the amount of energy required by the electric vehicle 110 per unit distance (e.g., mile, kilometer) traveled. The server 140 may further determine the amount of energy per unit time (e.g., second, minute) that the battery 114 of the electric vehicle 110 may receive, or another words how long it takes to recharge the battery to a specific amount of energy. The vehicle specifications 150 may further include data regarding the effects of the weight of cargo hauled by the electric vehicle 110 on its energy consumption.

The server 140 may have access to the calendar 152. The calendar 152 includes information related to the hours of the day, days of the week, months of the year and years. The calendar 152 may include information regarding holidays or other types of special days that may affect travel. The information from the calendar 152 may be used to determine a departure date and time. The calendar 152 may include information that is similar to the information maintained by the calendar application 132 on the user device 130, without the personal data stored by the user.

The server 140 may have access to the mapping data 154. The mapping data 154 may be used to plan how travel on the trip will be accomplished. Once the server 140 has determined the origin and the destination, the server 140 may use the mapping data 154 to determine a route from the origin to the destination and the amount of time it will take to traverse the route. The server 140 may use the mapping data 154 to determine a schedule for the trip. The server 140 may incorporate any stops made along the route into the time for traveling the route to produce a schedule for the route. The server 140 may subdivide the route into zero or more legs. Legs may be defined by desired or necessary stops (e.g., charging, tasks) along the route.

The mapping data 154 may include information that is used by a GPS receiver to determine a route between an origin and a destination. The mapping data 154 may include information related to the roads and/or highways of a region including speed limit, grade, traffic, the locations of services (e.g., charging stations, hospitals, post offices, gas stations, restaurants, hotels, banks, house addresses), historical sites, road names, highway numbers, intersections, road entrances, road exits, and so forth. The server 140 may also use elevation changes along the route to determine the effect on the energy consumption of the electric vehicle 110.

In the event that the mapping data 154 does not include data regarding charging stations, the server 140 may have access to the charging station data 156. The charging station data 156 includes information including the location, services provided, hours of operation and technical specifications of charging stations. The charging station data 156 may further include information for reserving a time for charging at a particular charging station. The information from the charging station data 156 may be used in conjunction with the mapping data 154 to identify charging stations along the planned route of travel. The mapping data 154 may be used to determine the distance between each charging station. The information from the charging station data 156 may be overlaid on the mapping data 154. The technical specifications from charging station data 156 may be used to determine the rate of energy delivery by the chargers of a charging station, which may be used to determine the amount of time the electric vehicle 110 will need to spend at the charging station.

It is possible, especially when the electric vehicle 110 is used in a commercial endeavor, that a person other than the driver can assign the driver to perform specific tasks while driving from the origin to the destination. For example, the driver may be assigned to make deliveries or pick up items while making the trip. The server 140 may use the data from the assigned tasks 158 to determine the route that should be traveled to accomplish the tasks and to travel from the origin to the destination. The server 140 may estimate the time required to stop to perform each task and incorporate that time into the schedule for the trip

The server 140 may further have access to driver information 160. The driver information 160 may include information regarding the manner in which the drives (e.g., economical, normal, aggressive), the driver's ability to drive in the dark, the frequency at which the driver should take breaks, and the driver's travel stop amenity (e.g., snacks, bathrooms, showers, hotel) preferences. Information regarding the driver may be used to determine a route and time of arrival. For example, a driver with an aggressive driving style may need to stop at more charging stations than a driver with an economical driving style. The driver who prefers more frequent stops may take longer to make the trip. Drivers who make long-haul trips (e.g., multi-day) may prefer occasional showers at stops. The server 140 uses driver information 160 to estimate the effect of the driver's habits and preferences on the trip schedule.

The server 140 may have access to the weather information 162. Weather information 162 may include information regarding temperature, precipitation, road closures, wind speed, wind direction and so forth. The information will likely be presented with respect to specific locations, so the server 140 may use information to determine possible road conditions. The server 140 may use the weather information 162 in determining a route (e.g., avoid closed roads), trip schedule (e.g., slower due to precipitation), time of arrival, and/or recharging.

### Trip and Preparation Timeline

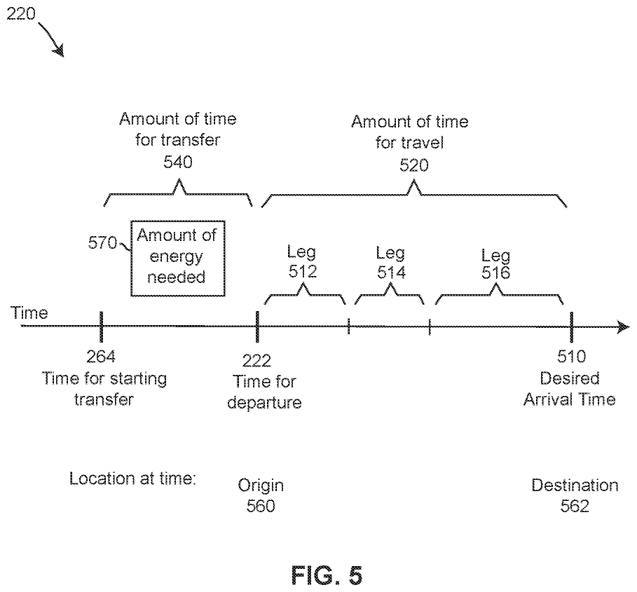

As discussed above, the server 140 may use the data it receives to determine a timeline of the trip. The server 140 may further determine the time at which charging the vehicle may need to start prior to the trip (e.g., time for starting transfer 264). In an example embodiment, the server 140 determines trip timeline 220, as best seen in FIG. 5. The server 140 sends messages to the user informing the user of trip related times.

As discussed above, the server 140 receives or determines the origin 560, destination 562 and desired arrival time 510. In an example embodiment, using the origin 560, the destination 562 and data from the databases 150-162, the server determines an amount of time for travel 520 from the origin 560 to the destination 562. The server 140 may identify legs 512-516 of the trip. The endpoint of each leg may correspond to a stop at a charging station, a stop to perform a task or a stop for the end of travel for the day. Using the amount of time for travel 520, the server 140 is configured to count back from the desired arrival time to determine a time (e.g., time of day) for departure 222. The server 140 sends a message to the user to inform the user of the time for departure 222.

The server 140 may also determine an amount of energy needed 570 by the electric vehicle 110 to travel from the origin 560 to the end of the first leg 512 or to the destination 562 for a trip that can be made on a single charge of the battery 114. The server 140 determines an amount of time to transfer 540 the amount of energy needed 570 to the battery 114. Using the amount of time to transfer 540, the server 140 is configured to count back from the time for departure 222 to determine a time for starting transfer 264. The time for starting transfer 264 is the time at which charging of the battery 114 should start, so the battery 514 has enough energy to make it to the end of the first leg 512 or to the destination 562. The server 140 sends a message to the user to inform the user of the time for starting transfer 264. This message informs the user to connect a residential charger to the electric vehicle 10 prior to the time for starting transfer 264 or to be ready to be at a charging station by the time for starting transfer 264.

Assume in this embodiment, that the server 140 receives information regarding all of the trips made by the electric vehicle 110. The server 140 may analyze the trip data to determine the likely location of the electric vehicle 110 at the time for starting transfer 264. If at the time for starting transfer 264, the vehicle is normally located at the user's residence, the server 140 may send a reminder to the user just before bedtime to remind the user to connect the in-residence charger to the electric vehicle 110. If at the time for starting transfer 264, the user is normally located at work, the server 140 may find a local (e.g., close, closest) charging station, or identify the charging station normally used by the user, as the location for charging the electric vehicle 110 before the trip. The server 140 may also set a reservation with the charging station reserving a time that provides enough time for charging prior to the time for departure 222. The server 140 may send a reminder of the time for starting transfer 264, the station with the charging will take place and the reservation information. The user may also specify the charging station and the server 140 may determine the amount of time for transfer 540 and the time for starting transfer 264 accordingly.

The rate of transfer of energy provided by various chargers may differ. For example, the rate of transfer of an in-residence will likely be less than the rate of transfer of a charger at a charging station. The amount of time for transfer 540, and therefore the time for starting transfer 264, depends on the charger being used to charge the battery 114. The server 140 may calculate the amount of time for transfer 540 and the time for starting transfer 264 for a variety of chargers close to the origin 560, send the information to the user and receive a selection from the user.

In one example scenario, the user connects the in-residence charger to the electric vehicle prior to going to bed. At 5 AM the user device and/or the server instructs the charger to deliver energy to the electric vehicle, so that by 7 AM, the battery holds enough energy to travel at least the first leg of the trip. In another example scenario, at the time charging is supposed to start, the user device and/or server determines that the charger is not connected to the vehicle, so the user device and/or the server sends a message to the user instructing the user to connect the charger to electric vehicle. Either the user will connect the in-residence charger or the user may elect to drive to a charging station to charge the battery. The user may inform user device and/or the server that charging will take place at a charging station. Since the charger at a charging station can deliver energy at a much higher rate than the in-residence charger, the user device and/or the server calculates a new value for the amount of time for transfer 540. The server 140 may calculate a new time for time to starting transfer 246 and inform the user that the user will need to be at the charging station at that time to start charging in order to reach the destination at the desired arrival time. For example, assume that it takes only 15 minutes to fully charge the battery at a charging station. The user device and/or the server would instruct the user to be at the charging station at or before 6:45 AM.

At the time for starting transfer 264, the server 140 may communicate with the electric vehicle 110 and/or the charger 112 to determine whether the charger 112 is connected to the electric vehicle 110. If the charger 112 is connected to the electric vehicle 110, the server 140 may instruct the charger 112 to begin charging the battery 114. If the battery 114 is being charged at a charging station and the charging process is already in progress at the time for starting transfer 264, the server 140 does nothing.

If the charger 112 is not connected to the electric vehicle 110 at the time for starting transfer 264, the server 140 is configured to send a notice to the user requesting that the user connect the charger 112 to the electric vehicle 110. Once the charger 112 is connected, the server 140 determines the rate of transfer of the charger 112. Depending on the rate of transfer of the charger 112, the server 140 may need to update the amount of time for transfer 540. If the updated amount of time for transfer 540 affects the estimated arrival time 224 at the destination 562, so that it is either earlier or later than the desired arrival time, the server 140 may so inform the user.

At the time for starting transfer 264, the server 140 may also query the electric vehicle 110 to determine the amount of energy stored on the battery 114. If the amount of energy stored on the battery 114 is less than the amount of energy needed 570, then the server 140 instructs the charger 112 to charge the battery 114 until it contains the amount of energy needed 570. If the amount of energy on the battery 116 is close to the amount of energy needed 570, charging the battery may not take the entire amount of time for transfer 540. The server 140 may send a message to the user to instruct the user to charge the battery 114 only to the amount of energy needed to traverse the first leg 512. The user may elect to follow the instructions of the server, terminate charging and start the trip. The user may also elect to either transfer the amount of energy needed or to fully charge the battery 114. If the user elects to fully charge the battery, the server 140 may calculate an updated amount of time for transfer 540 and inform the user of any impact that may have on the estimated arrival time 224 at the destination 562.

At the time for starting transfer 264, if the server 140 detects that the amount of energy stored on the battery 114 is more than the amount of energy needed 570 to traverse the first leg 512, the server may send a message to the user informing the user the charging is not necessary. The user may forgo charging or elect to continue charging the battery 114. As discussed above, if the user elects to fully charge the battery, the server 140 may calculate an updated amount of time for transfer 540 and inform the user of any impact that may have on the estimated arrival time 224.

### Data Determined by the Server

In an example embodiment, the server 140 may use information from databases 150-162 and the information from the user device 130 to determine the data 200. In an example implementation, the data 200 includes route information 210, weather information 230, task checklist 240 and pre-trip charging information 260. The route information 210 may include route 212, charging stations 214, minimum charge 216, stops along the route 218, schedule 220, time for departure 222 and estimated arrival time 224. The route 212 includes data regarding the route that should be traveled by the electric vehicle 110. The route 212 may be shown on a map. The map with the route 212 may be provided to a display (e.g., LCD screen, touchscreen) of the user device 130 for presentation to the user. Any information from data 200 may presented on the display of the user device 130 and/or a display of the electric vehicle 110. The server 140 may receive information from the electric vehicle 110 as to the present location of the electric vehicle 110 thereby enabling the server 140 to track the progress of the trip.

The charging stations 214 identifies charging stations along the route from origin 560 to destination 562. The charging stations 214 may further identify charging stations at which electric vehicle 110 should stop so as to not run out of energy. The information regarding the charging station identified for charging may be stored in stops along the route 218 to signify that a stop (e.g., pause) in the trip will be made at that location. The charging stations 214 may include information about the charging station, such as amenities, operating hours and wait times. The charging stations 214 may be provided to the user device 130 and/or the electric vehicle 110 for presentation to the user. The charging stations 214 may further include whether a reservation for charging services has been made at a charging station. It may further include information as to an estimated time to recharge the battery at the charging station.

Even though the server 140 has identified various charging stations where the electric vehicle 110 should be charged, the user may override any of the selections made by the server 140. The server 140 may receive information from the user device 130 as to any override or selection made by the user. If the user overrides a selection, the server 140 determines whether the electric vehicle 110 has enough energy to make it to the charging station selected by the user. The server 140 may use information regarding the charging station selected by the user to update any portion of the schedule of the trip including the estimated arrival time 224 at the destination 562. The server 140 may inform the user of any impact made on the schedule by the user's selection.

The minimum charge 216 provides information as to the minimum amount of charge (e.g., energy) that should be received at the identified charging station so that the electric vehicle 110 can make it to the next charging station. If the driver elects to fully charges the battery 114 at a charging station, the server 140 may update the trip information such as minimum charge 216, charging stations 214 and estimated arrival time 224. The server 140 may provide the minimum charge 216 information to the electric vehicle 110 and/or the charger 112 so that the electric vehicle 110 and/or the charger 112 may verify that minimum amount of energy is transferred. Transferring only the minimum amount of energy at each charging station may decrease the amount of time spent at each charging station as opposed to spending the time required to fully charge the battery.

The stops along the route 218 may also identify locations were stops should be made to perform an assigned tasks identified in tasks todo 246. The stops along the route 218 may identify locations where cargo is to be discharged or picked up. Cargo may include documents. The stops along the route 218 may be shown on the map. The stops along the route 218 may include an address where a stop is to be made. The stops along the route 218 may be provided to the user device 130 and/or the electric vehicle 110 for presentation to the user (e.g., driver). Time may be allotted for each stop. The schedule (e.g., timeline) 220 and or the estimated arrival time 224 may be updated if more or less time is spent at each stop.

The schedule 220 provides a timeline (e.g., schedule) of the trip as discussed with respect to FIG. 5. The schedule may include the time for departure 222, the estimated arrival time 224, the time at each stop identified in the stops along the route 218, the time allotted to spend at the charging stations identified in charging stations 214, the amount of time for travel 520 or along a portion of the route 212 (e.g., leg 512, leg 514, leg 516), or any other information related to the trip.

The time for departure 222 is the time of departure from the origin. The time for departure 222 takes into account the route 212, the speed limits along the route 212 and anticipated stops at charging stations and other stops along the route 212. The time for departure 222 may take into account and/or be affected by the vehicle specifications 150, the assigned tasks 158, the driver information 160 and/or the weather information 162. The time for departure 222 may be provided to the driver via the user device 130 and/or via messages to the user (e.g., email, text message, electric vehicle 110) through another device other than the user device 130.

The estimated arrival time 224 is the time at which the electric vehicle 110 should arrive at the destination 562. The goal of the planning is that the estimated arrival time 220 be close to the desired arrival time. The user may provide the desired arrival time to the server 140 via the user device 130. The server 140 may verify the desired arrival time with the user via the user device 130 and/or a message. If the user changes the desired arrival time or any stops along the route, the server 140 may update the time for departure 222 so that all the necessary stops may be made while still arriving at the destination at the desired arrival time. The updated departure time may be reported to the user device 130 for reporting to the user.

The weather information 230 includes weather data and data that is related to the weather (e.g., closures, accidents) along the route. The server 140 may use weather information 230 while determining which route is a good route to take. The weather information 230 may be provided to the user device 130 and/or the electric vehicle 110 to inform the driver regarding the weather along the route 212. The weather information 230 may be shown on the map presented by the user device 130 and/or the electric vehicle 110 to the user.

The server 140 may use information from the assigned tasks 158 to determine the task checklist 240. The task checklist 240 includes items to take 242, items to pick up 244, tasks todo 246 and location of tasks 248. The items to take 242 identifies items (e.g., things, documents) that need to be collected by the user for transport in the electric vehicle 110 along the route 212 to the location of the tasks 248. The stops along the route 218 identifies where the driver must stop to perform a task (e.g., drop-off, pickup, so forth). The items to take 242 identifies the items for transport by the driver to a specific location along the route. The location of tasks 248 may include a description of the location where the item should be dropped off. When the driver arrives at the destination, all of the items to take 242 should have been dropped off at a stop along the route 218. The items to take 242 may be sent to the user device 130 so that the user has a list of the items that should be in the electric vehicle 110 when the user departs on the trip.

Items to pick up 244 identifies items that the driver should collect something at one or more of the identified stops along the route 218. The items to pick up 244 identifies the item to be collected by the driver and the location along the route 212 where the driver should pick the item up. The items to pick up 244 provides a list of the items that the driver should have when the driver arrives at the destination. The items to pick up 244 may be sent to the user device 130 so that the driver has a checklist to ensure that each item is picked up.

The task checklist 240 may also include the assigned tasks 158 in the form of a list of tasks todo 246. The tasks todo 246 identifies tasks that the driver should perform at particular locations identified at stops along route 218. The tasks todo 246 identifies an action that the user is to perform at a location along the route. For example, the user may be assigned the task of driving to a particular location along the route 212 to open a valve on a water line. The user may be assigned the task of repairing an object positioned along the route 212, for example a sign or a traffic indicator. The tasks todo 246 combined with the items to take 242 and the items to pick up 244 enable a third party (e.g., a dispatcher, a supervisor) to provide the driver with work assignments to be performed along the route 212. The tasks todo 246 may be sent to the user device 130 to provide the driver with a checklist of each task to be performed.

The location of the tasks 248 is a list of the locations where each task is to be performed. The locations of the tasks 248 may be displayed with respect to a map of the route 212 and the items displayed on the map. The location of the tasks 248 may be coordinated with the action to be taken at each location. Location of the tasks 248 may be sent to the user device 130 and/or the electric vehicle 110 for presentation to the driver with the map data.

The pre-trip charging information 260 includes amount of energy needed 262 (e.g., 570), which is amount of energy (e.g., charge) that should be stored on the battery 114 prior to time for departure 222. As discussed above, if the present amount of energy stored by the battery 114 is greater than the amount of energy needed 262, the battery 114 need not be charged prior to starting the trip. If the present amount of energy stored by the battery 114 is less than the amount of energy needed 262, then energy should be transferred to the battery 114 until the amount of energy on the battery 114 is at least equal to the amount of energy needed 262.

The server 140 is adapted to control the operation of the charger 112. The server 140 may receive information from the electric vehicle 110 regarding the amount of charge presently on the battery 114. The server 140 may control the operation of the charger 112 to provide or not provide more energy to the battery 114.

### The Charger

An example embodiment of the charger 112 includes a processing circuit 410, a memory 412, a power supply 420, a connection sensor 430, a communication circuit 440, a charging cable 450 and a charging handle 460. The charging handle 460 electrically couples to the electric vehicle 110 to transfer energy from the power supply 420 to the battery 114 of the electric vehicle 110 via the charging cable 450 and charging handle 460. The power supply 420 provides a current to the battery of the electric vehicle 110 at a voltage. The current recharges (e.g., transfers energy to) the battery 114 of the electric vehicle 110.

The connection sensor 430 detects whether the charger 112 is electrically connected to the electric vehicle 110. In other words, the connection sensor 430 may detect whether the charging handle 460 is connected to the electric vehicle 110. The connection sensor 430 may also check the continuity of the electrical connection between the power supply 420, the charging cable 450, the charging handle 460 and the electric vehicle 110. The connection sensor 430 may report whether or not a connection is detected between the power supply 420 and the electric vehicle 110. In another example embodiment, the electric vehicle 110 also includes a connection sensor and may report to the server 140 and/or the user device 130 whether or not a connection is detected between the electric vehicle 110 and the charger 112.

The communication circuit 440 communicates with the server 140 and/or the user device 130 via the network 120. The processing circuit 410 controls performance of the functions (e.g., operation) of the charger 112. The memory 412 stores a program for execution by the processing circuit 410 that when executed causes the processing circuit 410 to controls operation of the charger 112. The processing circuit 410 may receive instructions from the server 140 and/or the user device 130 via the network 122 to perform one or more functions. For example, in an example embodiment, the server 140 and/or the user device 130 instructs the processing circuit 410 to charge the battery of the electric vehicle 110.

The server 140 and/or the user device 130 may further instruct the charger 112 to report whether the charger 112 is connected to the electric vehicle 110 and/or the charging capacity (e.g., rate of energy delivery) of the charger 112.

### Examples of Operation

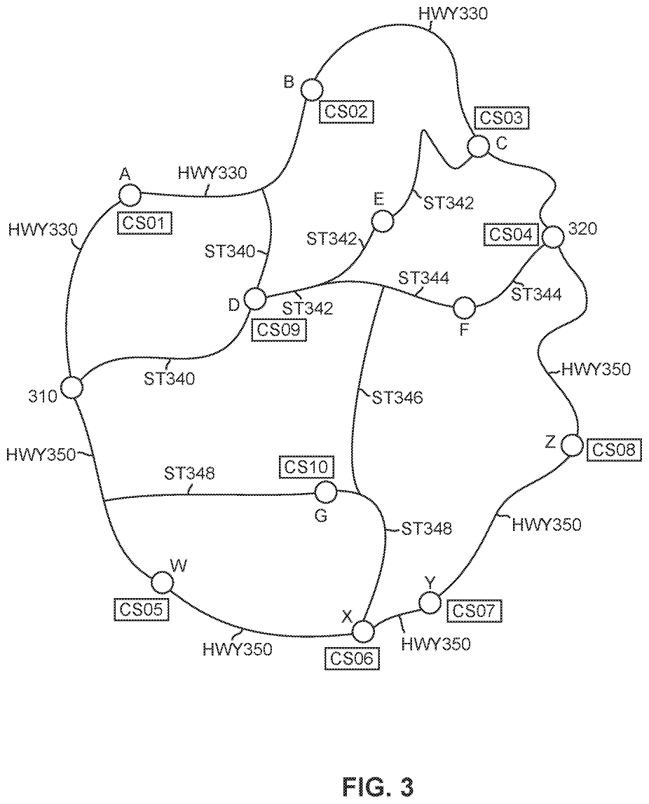

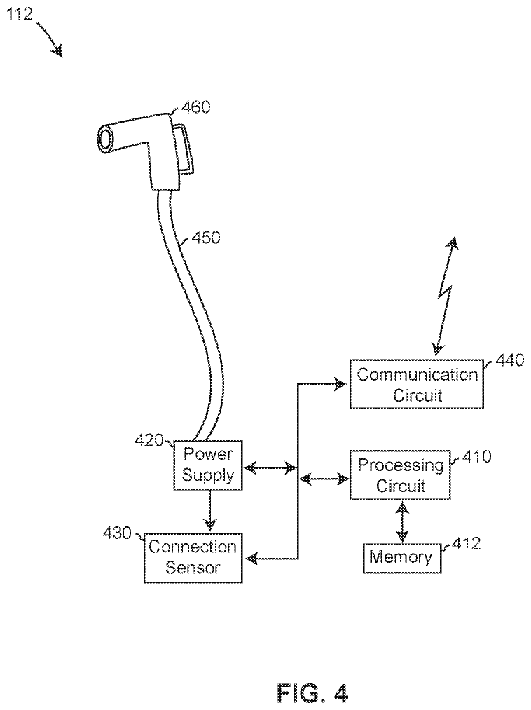

Below are provided examples of the cooperation between the server 140, the user device 130, the charger 112 and the electric vehicle 110 to prepare the electric vehicle 110 for a trip. In example of how the system operates, the user would like to use the electric vehicle 110 to travel from origin 310 to destination 320 as shown in FIG. 3. The driver uses the calendar application 132 to identify a date and a desired time of arrival at the destination 320. The server 140 receives the date, desired arrival time and destination from the user device 130 via the network 120. The server 140 may send a message to the user via the user device 130 to verify the date, the desired arrival time and the destination. The server 140 may further request the user to identify where the electric vehicle 110 will be located at the beginning of the trip. The server 140 may have stored various potential origins, such as the user's house or business, but the server 140 verifies the origin for the trip. The server may store the origin, the destination and the desired arrival time (not shown). In another example, the user uses the calendar application 132 to identify a date and a time of an appointment with a specific person. The server 140 accesses the contact application 134 to determine the location of the specific person, and therefore the destination for the appointment (e.g., trip). The server may verify the time of the appointment, the person with whom the appointment is scheduled, the location of the meeting (e.g., destination) and the location from which the user will depart (e.g., origin) with the user via the user device 130 or directly. The user may amend any information that is not correct.

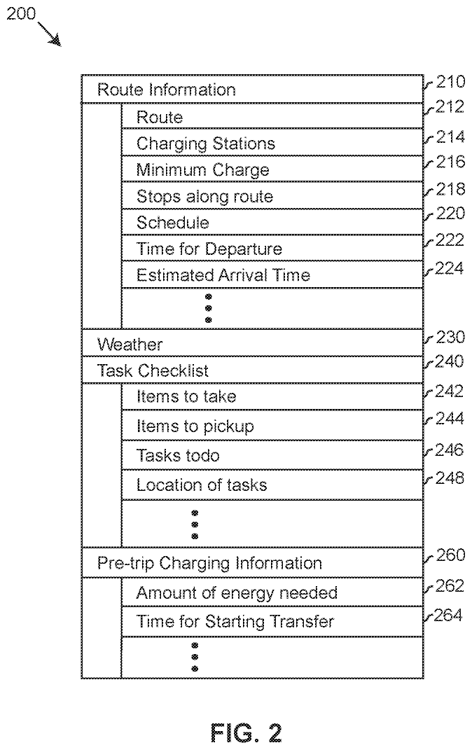

The server 140 stores the estimated (e.g., calculated) arrival time in data 200 as the estimated arrival time 224. The server 140 accesses map data 154 to determine the various routes that lead between the origin 310 and the destination 320. The server 140 may store both the origin and the destination (not shown in FIG. 2). In this example, the server 140 determines that various highways (e.g., HWY330, HWY350) and various state routes (e.g., ST340, ST342, ST344, ST346, ST348) provide passage between the origin 310 and the destination 320.

The server also uses the mapping data 154 to identify the cities (e.g., A, B, C, W, X, Y, Z) and towns (D, E, F, G) along the highways and state routes. The server 140 accesses charging station data 156 to identify the locations of charging stations (e.g., CS01, CS02, so forth) along the various highways and state routes. The server 140 may integrate the charging station locations with the data from mapping data 154 to show the location of the charging stations on the map.

In a first example, the server 140 determines that the assigned tasks 158 does not include any assigned tasks, so no stops for tasks need to be made. The server 140 assesses each potential route from the origin 310 to the destination 320. The server 140 may identify the route for travel in accordance with criteria such as shortest distance, fastest time, least elevation change, most scenic route, least energy used or any other criteria. In this first example, the server 140 determines that the route along highway HWY330 provides the fastest time.

The server determines that the battery of the electric vehicle 110 will need to be charged to at least 50% capacity prior to departure. If the battery is charged to less than 50% capacity, electric vehicle 110 cannot make it to charging station CS01 in city A. Even if the battery were to be charged to 100% capacity at the beginning of the trip, the electric vehicle 110 cannot make it to the charging station CS02 without stopping for charging in city A. The server 140 stores the value of 50% in amount of energy needed 262 to indicate that the battery 114 will need be charged to 50% of its capacity before departing on the trip.

The server 140 plans a route along highway HWY330. The battery will need to be recharged to at least 50% prior to departure, charged to at least 70% at CS01 and to 100% at CS02 in city B. The server stores the minimum amount of energy required at each charging station in the minimum charge 216. The server also stores the identities and locations of charging stations CS01, CS02 and CS03 in charging stations 214. If possible, the server reserves a charging time at each of the plan charging stations for the estimated time when the electric vehicle 110 will arrive at the charging station. The server 140 stores the reservation information. Server 140 may also provide technical (e.g., amount of energy needed, max rate of energy delivery) and identifying information (e.g., license plate, make, model number, VIN) of the electric vehicle 110 to the charging stations. The charging stations may use the information regarding the electric vehicle 110 to ensure that sufficient energy is available to charge the electric vehicle 110 when it arrives and/or that a charger suitable to the electric vehicle 110 will be available.

The server 140 calculates the time required to transit highway HWY330 between the origin 310 and the destination 320 driving the speed limit. Server 140 may further calculate the estimated amount of energy expended. The server 140 includes the estimated time for charging at charging stations CS01 and CS02. Estimated charging times may be provided by the charging stations. Using this information, the server 140 calculates a departure time and stores it as time for departure 222. The server 140 may further store the information as to the schedule of the trip in schedule 220. The schedule 220 may include an estimated arrival time 224 and departure from each charging station. If any stops are planned, the arrival and departure from each stop may also be estimated and stored. A lunch or rest break may also be included as a planned stop.

The server 140 may sum all of the times related to the trip along the route to determine amount of time for travel 520. Using the amount of time for travel, the server 140 may determine the time for departure 222. The server 140 may also determine the amount of time for transfer 540 to prepare the battery 114 for the first leg of the trip from the origin 310 two charging station CS01. Using the above data, the server 140 may calculate the time for starting transfer 264.

The server 140 reports the time for departure 222, the amount of energy needed 262, the time for starting transfer 264 and the estimated arrival time 224 to the user device 130 via the network 120. The user device 130 stores the information. The user device 130 may report the time for departure 222 to the user or the user may access the calendar application on the user device 130 to view the time for departure 222. If the desired arrival time, origin, destination or planned stops changes, the user device 130 may provide the updated information to the server 140 which repeats the process to determine the information.

In this example embodiment, the user reported to the server 140 that the origin will be the user's residence. In this example, the time for departure 222 has been determined to be 7 AM. Using the charger at the user's residence to charge the battery 114 to the amount of energy needed 226 of 50% will require four hours, so the time for starting transfer 264 is 3 AM. Because the user will not likely be up at 3 AM to connect the charger to the electric vehicle 110, the server 140 sends a message to the user to remind the user to connect the charger to the electric vehicle 110. In an example embodiment, the server 140 sends the reminder to the user when the electric vehicle 110 arrives at the user's residence. In another example embodiment the server sends the reminder to the user at 8 PM, which is prior to bedtime.

At the time for starting transfer 264, the server 140 requests information from the electric vehicle 110 as to the amount of energy on the battery 114 and whether the charger 112 is connected to the electric vehicle 110. In this example, the battery 114 is charge to 35%, so the server 140 knows that the full four hours will not be required to charge the battery 114 to 50% capacity. In one example embodiment, the server 140 recalculates the time for starting transfer 264 and instructs the charger 112 to start charging at a time later than 3 AM. In another example embodiment, the server 140 instructs the charger 112 to charge the battery starting at 3 AM and either stops charging the battery 114 reaches 50% capacity or transfers the previously planned amount of energy to the battery 114 so that the battery is charged to 85% capacity.

In another example embodiment, at 3 AM, the server 140 queries the charger 112 and the electric vehicle 110 to determine that the charger 112 is not connected to the electric vehicle 110. The server 140 at this point may send a message to the user requesting that the user connect the charger 112 to the electric vehicle 110. If the user connects the charger 112 to the electric vehicle 110, the server 140 instructs the charger 112 to transfer energy to the electric vehicle 110 as discussed above.

If the user does not connect the charger 112 to electric vehicle 110, other plans for charging the battery 114 prior to the time for departure 222 will need to be made. In one example embodiment, the server 140 sends one or more messages to the user at a time when the user might be awake (e.g., 6:30 AM) and before the time for departure 222. The messages inform the user that the battery lacks sufficient charge to travel the first leg of the journey. Depending on when the user responses, the in-residence charger may or may not be used. Its rate of transfer of energy may be too low to charge the battery 114 to 50% capacity before the time for departure 222. If there is not enough time to use the in-residence charger, the server 140 may identify and make a reservation at a local charging station that has a much higher rate of transfer. The server 140 informs the user of the charging station and the reservation, if made, and updates the schedule 220 accordingly. If the updated estimated arrival time 224 is later than the desired time of arrival, the server 140 informs the user.

A user may specify that the battery 114 of the electric vehicle 110 always be charged to near 100%. If the user has so specified, the server 140 calculates the time for starting transfer 264 accordingly. If the in-residence charger is connected to the electric vehicle 110, the server instructs the charger to start charging at the time for starting transfer 264. If there is not enough time to fully charge the battery 114 using the in-residence charger, the server 140 controls the charger to transfer enough energy to the battery 114 to at least arrive at charging station CS01. If enough energy cannot be transferred to the battery 114 to make it to charging station CS01, the server 140 arranges charging at a local charging station and informs the user.

In another example, the server 140 determines that the route along highway HWY330 is the best route. After calculating the amount of time for travel 520 and the time spent at charging stations, the server 140 accesses the weather information 162. The server 140 determines that there will be heavy precipitation between city B and city C during the trip, so the server 140 increases the amount of time to make the trip to account for the likely decrease in speed due to the precipitation. The server 140, using the estimated times, updates the time for departure 222 and the time for starting transfer 264. The server 140 reports the updated times and the weather along the route to the user device 130 and the electric vehicle 110 for access by the user.

In another example, the server 140 accesses assigned tasks 158 and discovers that a dispatcher has assigned the user of the electric vehicle 110 to perform various pickups and drop-offs. The tasks include delivering packages to cities G and Z and picking up packages at city E. The server 140 accesses mapping data 154 to determine the locations for drop-offs and pickup. The server 140 determines various routes that start at the origin 310 pass through the cities E, G and Z and end at the destination 320. The server 140 accesses the charging station data 156 to determine the locations of the charging stations along the potential routes. The server 140 accesses the vehicle specifications 150 to determine the energy expended per mile by the vehicle while carrying the packages for delivery and pickup. The server 140 accesses the assigned tasks 158 to determine the weight of the packages for delivery and pickup and uses that information to determine the gross weight of the electric vehicle 110 and any possible impact on the energy used per mile.

Using the above information, the server 140 analyzes the various routes in accordance with one or more criterion (e.g., shortest distance, fastest time, least elevation change, most scenic). In accordance with the one or more criterion, the server 140 selects the route to be traveled. The server stores the route in the route 212. The server calculates the time for departure 222 as discussed above. In this example, the route determined by the server 140 has the electric vehicle 110 travel from the origin 310 to City E along state routes ST340 and ST342 to pick up the packages at City E. From City E, the electric vehicle 110 should travel back along state Route ST342 toward City D, then turn on to state route ST346 toward city X. At the intersection of state routes ST346 and ST348, the electric vehicle 110 turns onto state route ST348 and drives to City G to drop off packages. From City G, the electric vehicle 110 drives back along state Route ST348 toward City X then along highway HWY350 toward City Z. At City Z, the driver drops off additional packages. The electric vehicle 110 continues along highway HWY350 to the destination 320.

The server also determines that the battery of the electric vehicle 110 should be charged to at least 50% prior to departure, charged to 100% at charging station CS09 in City D, charged to 100% at charging station CS10 in City G, and charged to at least 70% at charging station CS08 in City Z. The charging information is stored in minimum charge 216. The server 140 also determines the amount of time for travel 520, which includes the time spent at charging stations, at drop off points and at pickup points to determine the time for departure 222.

In another example, the server 140 accesses the assigned tasks 158 and learns of the packages that need to be dropped off in the Cities G and Z and the packages that need to be picked up in City E. The server 140 also accesses the weather information 162 to determine that the state highway ST346 between the state highways ST344 and ST348 is closed due to heavy snowfall. The server 140 then assesses all of the routes that start at the origin 310, pass through the Cities E, G and Z and end at the destination 320, but that do not use state route ST346.

After analyzing the potential routes, the server 140 determines that the best route is for the electric vehicle 110 to travel from the origin 310 is along highway HWY350 toward the intersection with state route ST348. The electric vehicle 110 exits highway HWY350 and takes state route ST348 to City G, where the user drops off packages. From City G, the electric vehicle 110 continues along the state route ST348 toward City X. At the intersection of state route ST348 and highway HWY350, the electric vehicle 110 takes the highway HWY350 toward City Z. After dropping off packages in City Z, the electric vehicle 110 continues along highway HWY350 toward City C. Even though the electric vehicle 110 passes through the destination 320 enroute to City C, the driver needs to pick up packages from City E, so the electric vehicle 110 passes through the destination 320 and at City C and takes the state route ST342 to City E. After picking up packages from City E, the electric vehicle 110 returns to the destination 320 along the state route ST342 and the highway HWY330.

The server also determines that the battery of the electric vehicle 110 should be charged to at least 80% prior to departure, charged to at least 80% at charging station CS10 in City G, charged to at least 80% at charging station CS06 or CS07 in City X or City Y respectively, charged to 100% at charging station CS08 in City Z, and charged to at least 70% at charging station CS03 when the electric vehicle 110 first arrives at City C.

### Control of the Schedule

In an example embodiment, the user of the user device 130 may have control of the use and operation of the electric vehicle 110, as a personal vehicle, and thereby may determine the date and desired arrival time at the destination 320. In another example embodiment, a dispatcher or a supervisor has control of the desired arrival time at the destination 320 in addition to any assigned tasks along the route. Each time the user, the dispatcher or the supervisor changes the desired arrival time, the destination and/or stops along the route, the server 140 performs calculations to determine how the data of data 200 and/or other data discussed above is affected.

In an example embodiment, the user determines and specifies the date and time of arrival at the destination 320 via the user device 130. The user may specify via the user device 130 that the user is willing to perform tasks assigned by a third party. The user may be selected tasks from the assigned tasks 158. The server 140 may determine route information 210, the task checklist 240 and/or the pre-trip charging information 260 in accordance with the desired arrival time specified by the user and the tasks accepted by the user from the assigned tasks 158. An arrangement that allows the user to select tasks from a source of tasks, such as the assigned tasks 158, enables third parties to post tasks to the assigned tasks 158 in the hopes that they will be performed.

### Example Method 600

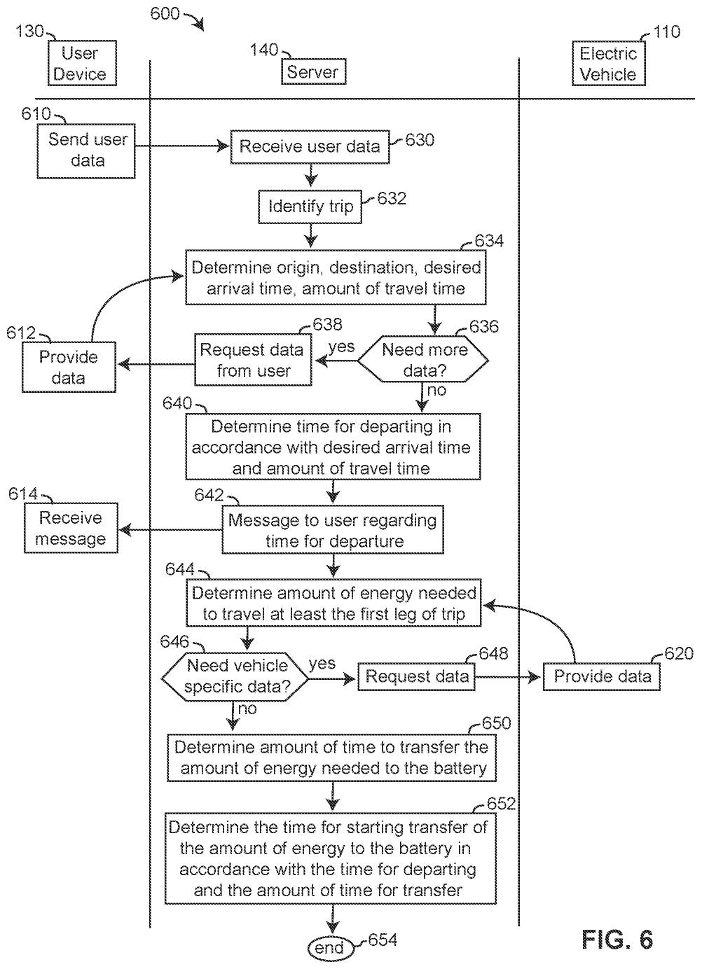

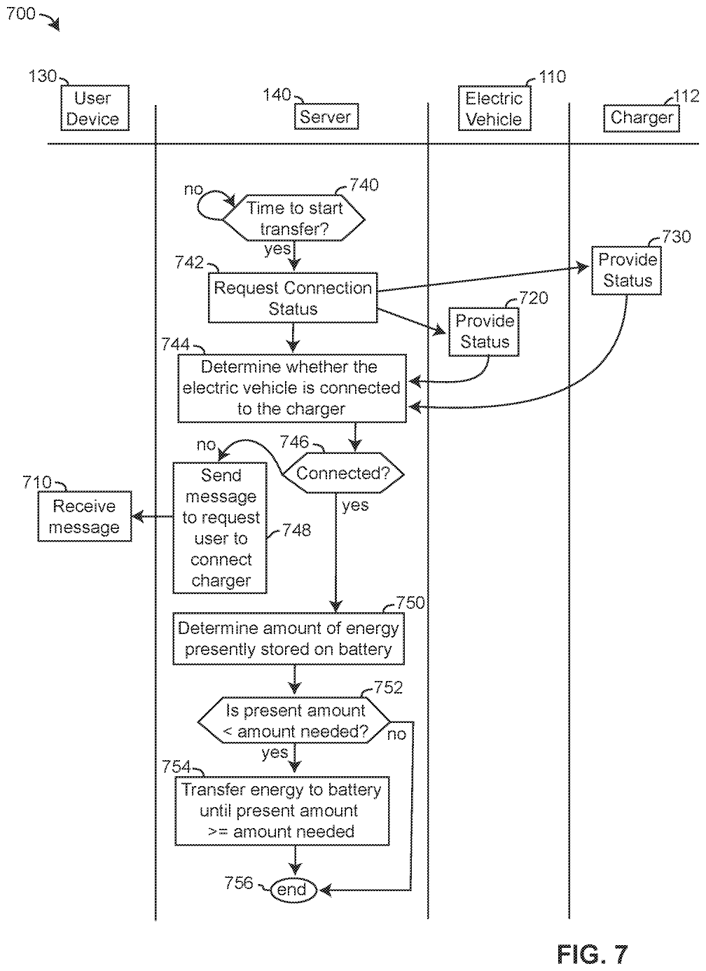

Methods 600 and 700 of FIGS. 6 and 7 are example embodiments of methods performed by the server 140 to prepare the electric vehicle 110 for a trip. Method 600 includes the operations send 610, provide 612 and receive 614, which are performed by the user device 130; the operations receive 630, identify 632, determine 634, need 636, request 638, determine 640, message 642, determine 644, need 646, request 648, determine 650, determine 654 and end 656, which are performed by the server 140; and the operation provide 620 which is performed by the electric vehicle 110. The flow (e.g., order) of execution of the operations is shown in FIG. 6.

In the operation send 610, the user device 130 sends user data to the server 140. User data includes data from the calendar application 132, the contact application 134 and the todo application 136. The user may also provide information, that is not handled by these applications, that is sent to the server 140.

In the operation receive 630, the server 140 receives the user data sent by the user device 130 in operation send 610. The server 140 may store the user data.

In the operation identify 632, the server 140 uses the user data to identify a trip that the user intends to take.

In the operation determine 634, the server 140 attempts to determine the origin, the destination and the desired arrival time for the trip. The server 140 also attempts to determine the amount of time for travel 520. As the server 140 attempts to determine this information, the server 140 may determine that it needs additional information. Additional information may be received from one or more databases and/or from the user, via the user device 130.

In the operation need 336, the server 140 determines whether it needs additional information from the user.

In operation request 638, the server 140 has determined in the operation need 336 that additional information is needed. In request 338, the server 140 requests the additional information from the user. The server 140 requests the information by sending a message to the user device 130.

In the operation provide 612, the user device 130 receives the request for additional data, gets the data and provides the data to the server 140. It is possible, that the user device 130 has the requested information and may provide the information to the server 140 without user intervention. More likely, the user device 130 does not have the information, so it must be provided by the user. In this case, the user device 130 requests the information from the user. The user device 130 may request information by presenting the request on the display of the user device, audibly requesting the information from the user or by using any other method for getting the user's attention and identifying the needed information. The user may provide the information via the user interface (e.g., keyboard, voice recognition) on the user device 130. Once the user device 130 has request information, it sends the information to the server 140.

In the operation determine 640, the server 140 uses information from the user device 130 plus other data, such as data from the databases 150-162, to determine the amount of time for travel 520. The amount of time for travel 520 includes driving time and any needed or desirable stops along the route. The server 140 then count backwards from the desired arrival time to determine the time for departure 222. The server 140 stores the data it has determined and also stores the desired arrival time as the estimated arrival time 224. The server 140 stores any applicable information it has calculated or received in route information 210, whether 230 and task checklist 240.

In the operation message 642, the server 140 sends a message to the user, via the user device 130, that informs the user of the time for departure 222. The server 140 may send any other calculated or received information, that may be of interest user, in the message. The user device 130 presents the message and its associated data to the user.

In the operation receive 614, the user device 130 receives the message from the server 140 regarding the time for departure 222. The user device 130 may provide the message to the user.

In the operation determine 644, the server 140 attempts to determine the amount of energy needed by the electric vehicle 110 to travel at least the first leg of the journey. The amount of energy needed is the amount of energy that needs to be stored on the battery 114 before starting the trip, as discussed above. Once the server 140 has the information it needs, the server 140 calculates the amount of energy needed.

In the operation need 646, the server 140 determines whether it has information it needs to calculate the amount of energy needed. The server 140 may need information regarding the vehicle specifications or economy information from the electric vehicle 110.

In operation request 648, the server 140 requests the information it needs to determine the amount of energy needed. Operation request 648 may send a message to the electric vehicle 110 for information. Operation request 648 may access the vehicle specifications 150 to get the information it needs.

In the operation provide 620, the electric vehicle 110 receives the request for additional information from the server 140. The electric vehicle 110 gets the requested information and sends the information to the server 140.

In the operation determine 650, the server 140 determines the amount of time for transfer 540 needed to transfer the amount of energy needed prior to leaving on the trip to the battery 114. In determining the amount of time for transfer 540, the server 140 may assume that a particular charger will provide the energy to the battery 114. The assumption may be based on the origin of the trip. The operation determine 650 may send a message to the user asking the user to specify where the battery 114 will be charged prior to leaving on the trip. If the user selects a specific charger or charging station, the server 140 may make a reservation for charging at the charging station selected by the user at a time that allows sufficient time to charge the battery 114 with the amount of energy needed. The server 140 uses the rate of energy transfer for the charger to determine the amount of time for transfer 540.

In the operation determine 654, the server 140 counts back from the time for departure 222 the amount of time for transfer 540 to determine the time for starting transfer 264. The time for starting transfer 264 is the time of day by which the particular charger used to determine the amount of time for transfer 540 must start transferring energy to the battery 114. If the charger does not start transferring energy at the time for starting transfer 264, the battery 114 will not hold the amount of energy needed to travel at least the first leg of the trip. The server 140 sends a message to the user informing the user of the time for starting transfer 264.

### Example Method 700

The example method 700 includes the operation receive 710, which is performed by the user device 130; the operation provide 720, which is performed by the electric vehicle 110; the operation provide 730, which is performed by the charger 112; and the operations time 740, request 742, determine 744, connected 746, send 748, determine 750, present 752, transfer 754 and end 756, which are performed by the server 140.

In the operation time 740, the server 140 determines whether the time of day has reached the time for starting transfer 264. If the time is not yet the time for starting transfer 264, the method 700 does not start. At the time is the time for starting transfer 264, the operation requesting is executed.

In the operation requesting 742, the server 140 requests the status of a connection between the electric vehicle 110 and the charger 112 that will be used to charge the battery 114 prior to the trip. To request the status, the server 140 sends a message to the electric vehicle 110 and/or the charger 112 that requests the electric vehicle 110 and/or the charger 112 to determine whether the charger 112 is connected to the electric vehicle 110 and to return status to the server 140.

In the operation provide 720, the electric vehicle 110 receives the message from the server 140, determines whether it is connected to the charger 112 and sends a message with the status to the server 140.

In the operation provide 730, the charger 112 receives the message from the server 140, determines whether it is connected to the electric vehicle 110 and sends a message with the status to the server 140.

In the operation connected 740, the server determines whether the electric vehicle 110 is connected to the charger 112. If the charger is not connected, execution moves to send 748. If the charger 112 is connected to the electric vehicle 110 or once the charger 112 is connected to the electric vehicle 110, execution moves to determine 750.

In send 748, the server 140 sends a message to the user via the user device 130 requesting the user to connect the charger 112 to the electric vehicle 110.

In receive 710, the user device 130 receives the message from the server 140. The user device 130 presents the message to the user. Presenting the message does not guarantee that the user will respond or comply.

In the operation determine 750, the server 140 determines the amount of energy presently stored on the battery 114. The server 140 may determine this information by requesting the information from the electric vehicle 110.

In operation present 752, the server 140 determines whether the amount of energy presently stored on the battery 114 is less than the amount of energy needed to drive at least the first leg of the trip. If the amount of energy presently stored on the battery 114 is more than or equal to the amount of energy needed, no further action need be taken because the battery 114 has enough charge to drive the first leg of the trip. If the amount of energy presently stored on the battery 114 is less than the amount of energy needed then execution moves to transfer 754. Otherwise, execution of the method 700 ends.

In transferring 754 the charger 112 transfers energy to the battery 114 until the amount of energy presently stored on the battery 114 is greater than or equal to the amount of energy needed to drive at least the first leg of the trip.

### Afterword

The foregoing description discusses embodiments (e.g., implementations), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A method for preparing an electric vehicle for travel, the method performed by a server or a user device, the method comprising:
identifying in a calendar data of a user an information regarding a trip;
with respect to the trip, determining an origin, a destination, a desired arrival time, a first amount of time for travel from the origin to the destination;
determining a first time for departure in accordance with the desired arrival time and the first amount of time for travel;
sending a first message to the user to inform the user of the first time for departure.
determining a first amount of energy needed for the electric vehicle to travel at least a first leg of the trip;
determining a second amount of time to transfer the first amount of energy from a charger to a battery for storage by the battery;
determining a second time for starting transfer of the first amount of energy to the battery from the charger in accordance with the first time for departure and the second amount of time to transfer; and
sending a second message to the user to inform the user that the electric vehicle should be connected to the charger at or before the second time.

2. The method of claim 1 wherein sending the first message to the user further comprises sending a data to the user device to update the calendar data.

3. The method of claim 1 wherein the first amount of time for travel includes one or more amounts of time for stopping at one or more charging stations to recharge the battery of the electric vehicle.

4. The method of claim 1 wherein the first amount of time for travel includes one or more amounts of time for rest breaks.

5. The method of claim 1 determining the origin comprises analyzing the calendar data of the user to determine a location of the user prior to the trip.

6. The method of claim 1 determining the origin comprises sending a third message to the user requesting a location of the origin.

7. The method of claim 1 determining the destination comprises analyzing a contact data of the user to determine the destination.

8. The method of claim 1 determining the destination comprises sending a third message to the user requesting a location of the destination.

9. The method of claim 1 determining the desired arrival time comprises analyzing the calendar data.

10. The method of claim 1 determining the desired arrival time comprises sending a third message to the user requesting the desired arrival time.

11. The method of claim 1 determining the first amount of time for travel from the origin to the destination comprises:
accessing map data to determine a route, a distance along the route, a speed limit along the route and a location of one or more charging stations along the route; and
summing an amount of time for traversing each leg along the route and one or more amounts of time for stopping to charge the battery of the electric vehicle.

12. The method of claim 1 wherein summing further comprises summing one or more amounts of time for rest breaks.

13. The method of claim 1 the charger is located in a residence of the user.

14. The method of claim 1 wherein at or a third amount of time before the second time for starting transfer, the method further comprising:
determining whether the electric vehicle is connected to the charger; and
if the charger is not connected to the electric vehicle, sending a third message to the user requesting the user to connect the electric vehicle to the charger.

15. The method of claim 14 wherein determining whether the electric vehicle is connected to the charger comprises sending a fourth message to at least one of the electric vehicle and the charger requesting connection status.

16. The method of claim 14 wherein the third amount of time is between 5 and 30 minutes.

17. The method of claim 1 wherein at or a third amount of time before the second time for starting transfer, the method further comprising:
determining whether the electric vehicle is connected to the charger; and
if the charger is connected to the electric vehicle:
determining a second amount of energy presently stored on the battery; and
if the second amount of energy presently stored on the battery is less than the first amount of energy, instructing the charger to transfer energy to the battery until the second amount of energy presently stored in the battery is at least the first amount of energy.

18. The method of claim 17 wherein determining the second amount of energy presently stored on the battery comprises sending a third message to at least one of the electric vehicle and the charger requesting an information regarding the second amount of energy presently stored on the battery.

19. A method for preparing an electric vehicle for travel, the method performed by a server or a user device, the method comprising:
identifying in a calendar data of a user an information regarding a trip;
with respect to the trip, determining an origin, a destination, a desired arrival time, a first amount of time for travel from the origin to the destination;
determining a first time for departure in accordance with the desired arrival time and the first amount of time for travel;
sending a first message to the user to inform the user of the first time for departure.
determining a first amount of energy needed for the electric vehicle to travel at least a first leg of the trip;
determining a second amount of time to transfer the first amount of energy from a charger to a battery for storage by the battery;
determining a second time for starting transfer of the first amount of energy to the battery from the charger in accordance with the first time for departure and the second amount of time to transfer;
sending a second message to the user to inform the user that the electric vehicle should be connected to the charger at or before the second time;
at or a third amount of time before the second time for starting transfer:
determining whether the electric vehicle is connected to the charger;
if the charger is not connected to the electric vehicle, sending a message to the user requesting the user to connect electric vehicle to the charger; and
if the charger is connected to the electric vehicle, instructing the charger to transfer energy to the battery until a second amount of energy presently stored on the battery is at least the first amount of energy.

20. A method for preparing an electric vehicle for travel, the method performed by a server or a user device, the method comprising:
receiving a calendar data from a user device, the calendar data maintained by a user of the user device;
analyzing the calendar data to identify an origin, destination and a desired arrival time at the destination.
determining a first amount of time for travel from the origin to the destination including one or more stops for at least one of charging a battery of the electric vehicle and taking a break;
in accordance with the desired arrival time and the first amount of time, informing the user of a first time for departure;
determining a first amount of energy needed by the electric vehicle to travel at least one of a first leg of a trip and to the destination without recharging;
determining a second amount of time to transfer the first amount of energy from a charger to the battery of the electric vehicle for storage by the battery;
determining a second time for starting transfer of the first amount of energy to the battery in accordance with the first time for departure and the second amount of time to transfer, the second time is prior to the first time; and
informing the user of the second time for starting transfer.
